(19) United States
(12) Patent Application Publication
(10) Pub. No.: US 2004/0041842 A1
(43) Pub. Date: Mar. 4, 2004

(54) Touchscreen with internal storage and input detection

(76) Inventor: Douglas E. Lippincott, Anaheim, CA (US)

Correspondence Address: STETINA BRUNDA GARRED & BRUCKER, 75 ENTERPRISE, SUITE 250, ALISO VIEJO, CA, 92656, US

(21) Appl. No.: 10/228,891

(22) Filed: Aug. 27, 2002

(51) Int. Cl. G09G 5/00

(52) U.S. Cl. 345/783

(57) ABSTRACT

A system and method for selecting the active input/output port for a computer having a plurality of input/output ports of different are disclosed. The computer is in communication with and an input device connected to the computer via one of the input/output ports. The system includes an input sensor for receiving an input signal and an input device controller in communication with the input sensor and with the computer. The input device controller includes an input interface configured to receive an input signal from the input sensor and a communications processor configured to receive the input signal from the input/output ports, determine which of the input/output ports received the input signal, select the input/output port that received the input signal as the active input/output port and utilize the active input/output port for communication.

### BACKGROUND OF THE INVENTION

The present invention relates generally to computer input devices, and more particularly to an input device, such as a touchscreen monitor, that allows for different types of connections to a computer, with automatic determination of the connection type to be used.

The vast majority of touch-input subsystems within touchscreen monitors have been connected to computers utilizing standard (RS-232) low-speed serial input/output ports. In recent years, Universal Serial Bus (USB) input/output ports have also been used to connect touch-input subsystems within touchscreen monitors to computers. The touchscreen controllers that are typically contained within touchscreen monitors are generally designed to support just one type of connection technology, such as serial or USB. Because of this, dealers typically must stock both touchscreen monitors that have only a serial input/output port and touchscreen monitors that have only a USB input/output port.

The applicant is aware of one touchscreen controller, manufactured by 3M® Touch Systems™, which provides two input/output ports, one for a serial connection and the other for a USB connection, wherein one and only one input/output port may be active at any given time, as determined by the position of a jumper on the touchscreen controller circuit board. As most touchscreen controllers are mounted within a monitor, changing the 3M® controller from one connection mode to the other would typically require disassembly of the monitor to access the touchscreen controller, an operation that is not acceptable or suitable for the typical touchscreen customer.

Thus, there is a need for a methodology that allows a computer input device, such as a touchscreen monitor, to be connected to a computer using one of a plurality of interconnection technologies, such as USB and serial, where the type of connection used is automatically determined without user intervention.

Although still widely used, serial input/output port connections on computers are gradually becoming obsolete because of numerous limitations relating to speed and device count limitations. Generally, only one touchscreen controller can be connected to each serial input/output port on a computer.

USB connections address the limitations of serial input/output ports by operating at much faster speeds and by allowing multiple devices to be connected to a single USB input/output port on a computer by utilizing simple port-sharing devices called USB hubs.

However, USB technology has a significant limitation when trying to utilize multiple touchscreen monitors with a single computer. Specifically, USB technology lacks the ability to reliably identify which touchscreen has been activated when multiple touch-screens are connected to a single computer. Typically this problem is addressed by displaying a message on the first touchscreen monitor attached to a computer and asking the user to touch the touch sensor corresponding to and physically attached to that first touchscreen monitor, and then repeating this display-message-and-request-touch process for each additional touchscreen monitor attached to the computer. An association table is built for the arbitrary codes that the USB control software assigns to each USB device connected to a computer, matching that code with a particular display port. The problem with this approach arises when another USB device is added or deleted, or when a touchscreen is disconnected and then reconnected. These operations generally trigger a process termed “USB device re-enumeration” which can result in changes to the arbitrary codes assigned for each USB device, rendering the touchscreen-to-monitor association table invalid.

Therefore, there is also a need for a methodology for reliably determining which touch-input subsystem is associated with a particular touchscreen monitor when USB connection technology is used to attach more than one touchscreen monitor to a particular computer.

The raw touch-position data provided by a touch-input subsystem is arbitrary in terms of scaling with respect to the image shown on the underlying display subsystem, and it may include further errors as a result of touch sensor mounting offsets and rotational errors as well as touch sensor non-linearities. A software program that is typically executed on a computer to which a touchscreen monitor has been attached is used to perform a process termed “calibration” in which parameters are determined that can be subsequently used to correct for these errors. The most common type of calibration process operates by displaying one or more “touch-here” targets at known locations on the display subsystem and then determines the value reported by the touch-input subsystem when it is touched at the corresponding location. A set of data-correction parameters, termed “calibration data,” is derived from these touch-location values during the calibration process, and these parameters are stored for subsequent utilization by a data-correction sub-process. The function of the data-correction sub-process is to receive raw touch-position data produced by the touch-input subsystem, process it to correct for the various errors described in this paragraph and produce “calibrated touch-position data” as output. The correction process typically utilizes simple matrix transformation and/or interpolation methodologies, with the calibration data as fixed parametric input, to accurately determine the location of the touch across the entire surface of the touch sensor. Software residing on the computer, termed “driver software,” usually contains the logic required to perform this data-correction sub-process.

While a single calibration point may be adequate to correct for simple offset errors, and two calibration points are adequate to correct for both scaling and offset errors, some technologies may require as many as 25 separate calibration points to adequately compensate for significant non-linearities within the touch sensor. Most frequently the set of data-correction parameters (e.g., the calibration data) is stored within the computer's storage subsystem. If it becomes necessary to replace a touchscreen monitor after calibration in prior art systems, because of equipment failure or other reasons, significant errors may occur during the data-correction process unless a new calibration procedure is performed because the calibration data (e.g., the data-correction parameters) can vary significantly between touch-input subsystems, even of the same model. Unfortunately, an individual replacing a failed touchscreen monitor in these situations may lack the skill, training, patience and/or motivation needed to accurately perform the new calibration procedure required for accurate operation of the data-correction process. This can be especially true where there is an extreme urgency to restore a failed system to operation and an unskilled user is performing the repair, as might be the case in a fast-food restaurant, and the problem will be further compounded if the calibration process involves numerous calibration points.

While certain linearization data is sometimes stored in a non-volatile memory device attached to the touch sensor's connector with certain touchscreen sensor technologies, data-correction parameters to compensate for scaling and offset errors are generally still stored within the host computer's storage subsystem in these cases, which can again results in substantial errors if the entire touchscreen monitor is replaced after the calibration procedure has been performed.

Furthermore, if someone attempts to perform a new calibration procedure on a touchscreen monitor after installation, any data-correction parameters determined by the manufacturer during an initial factory calibration process will typically be over-written in prior art systems. This can result in a situation from which recovery would be difficult if the individual performing the new calibration procedure lacks the skill, training, patience or motivation to properly perform the calibration procedure.

Therefore, there is also a need for a method for uniquely associating the calibration data for a particular touch-input subsystem with a touchscreen monitor as a singular replaceable component subsystem.

### BRIEF SUMMARY

A method for selecting an active input/output port to be used for communicating between a computer input device and a computer is disclosed. The method provides the computer input device having at least two input/output ports that are different types of input/output ports. Each of the at least two input/output ports are monitored for an input signal until an input signal is received over one of the input/output ports. The input/output port that received the input signal is selected as the active input/output port to be used for communication between the computer input device and the computer.

Preferably, the method determines an expected protocol for each of the at least two input/output ports and verifies that the input signal received is the expected protocol for the input/output port that received the input signal.

The method may also include monitoring each of the at least two input/output ports and a sensor interface port for an input signal until an input signal is received over one of the input/output ports or the sensor interface port. If the input signal was received over one of the input/output ports, selecting the input/output port that received the input signal as the active input/output port and if the signal was received over the sensor interface port, selecting a serial port as the active input/output port.

The input device may be a touchscreen monitor.

The different types of input/output ports may include a serial input/output port and a USB input/output port.

A system for selecting the active input/output port for a computer having a plurality of input/output ports of different is disclosed. The computer is in communication with and an input device connected to the computer via one of the input/output ports. The system includes an input sensor for receiving an input signal and an input device controller in communication with the input sensor and with the computer. The input device controller includes an input interface configured to receive an input signal from the input sensor and a communications processor configured to receive the input signal from the input/output ports, determine which of the input/output ports received the input signal, select the input/output port that received the input signal as the active input/output port and utilize the active input/output port for communication.

The system may include a serial port and a sensor interface port. The communications processor selects the serial port as the active input/output port if an input signal is received over the sensor interface port prior to a signal being received over one of the input/output ports.

Preferably, the system also includes non-volatile data storage that can be accessed by the communications processor. The non-volatile data storage used for storing the logic and data used by the communications processor.

Preferably, the communications processor is configured to validate that the input signal received from the input/output port is a valid input signal for the input/output port.

A method for a single computer to communicate with a plurality of input/output device pairs connected to the computer, each of the input/output device pairs comprising an input device, an output device and an input device controller, the output device being addressable by a specific computer display port is disclosed. The method obtains a unique identification code from the input device controller for each of the input/output device pairs connected to the computer. A table is created associating each unique identification code with the specific computer display port for the output device. Input from the input device controller is obtained in a way that allows the unique identification code to be determined from input received from the input device controller. An identification of the specific computer display port for the display device is retrieved from the table. Output is transmitted to the output device via the specific computer display port based on the unique identification code.

The input/output device pairs may be touchscreen monitors.

The computer may communicate with the input/output device pairs using USB technology. The input/output device pairs communicate may communicate with the computer via a USB hub.

The unique identification code may be a serial number for the controller.

A method for uniquely associating calibration data for a particular touchscreen input subsystem including a touchscreen controller with a touchscreen monitor as a singular replaceable unit is disclosed. An initial factory calibration process is performed to derive factory calibration data. The factory calibration data is stored in non-volatile memory in the touchscreen controller.

Preferably, a user calibration process to derive user calibration data is also performed with the user calibration data being stored in non-volatile memory in the computer.

The method may also receive raw touch-position data and convert the raw touch-position data to calibrated touch-position data. The raw touch-position data is converted to calibrated touch-position data by: retrieving the factory calibration data; performing a first data-correction process using the factory calibration data to determine calibrated touch-position data. If there is user calibration data, the user calibration data is retrieved and a second data-correction process using the user calibration data that modifies the calibrated touch-position data is performed. The calibrated touch-position data is then stored.

A manufacturer may invoke the initial factory calibration process. An end user may invoke the user calibration process.

A method for a computer to find specific data within variably-sized non-volatile memory device addressable by a controller is disclosed. A limited number of predesignated locations in the non-volatile memory device for storage of the specific data are defined. A unique predetermined bit pattern is written to one of the predesignated locations for the specific data. The unique predetermined bit pattern is known to the computer. The specific data is written in a predefined area adjacent to the predesignated location to which the unique predetermined bit pattern was written.

The method may also search for the unique predetermined bit pattern at the limited number of predesignated memory locations and write the specific data to the predefined area adjacent to the predesignated location to which the unique predetermined bit pattern was written.

The specific data may be read from the predefined area adjacent to the predesignated location to which the unique predetermined bit pattern was written.

The data stored in the touchscreen controller may or may not be directly related to the touchscreen operation.

The specific data may be calibration data.

The specific data may be a unique identification code. The unique identification code may be a serial number.

A copy of the specific data may be written to non-volatile memory of the computer in a way that survives power interruptions.

Preferably, the specific data includes cyclical redundancy check data.

Preferably, the specific data is aligned on a page boundary for the non-volatile memory device to minimize page writes and thereby maximize life of the non-volatile memory device.

### BRIEF DESCRIPTION OF THE DRAWINGS

These as well as other features of the present invention will become more apparent upon reference to the drawings wherein:

FIG. 1 is a block diagram of an exemplary computer system;

FIG. 2 is a block diagram of an exemplary touchscreen monitor which can be used in the computer system shown in FIG. 1;

FIG. 3 is a block diagram of an exemplary touch-input subsystem component of a touchscreen monitor such as the one shown in FIG. 2;

FIG. 4 is a block diagram of an exemplary touchscreen controller component of a touch-input subsystem such as the one shown in FIG. 3;

FIG. 5 is a block diagram of a multi-port interface component, typically contained within a communications processor such as the one shown in FIG. 4, that can determine which input/output port is connected to a computer such as the one in FIG. 1 and route signals accordingly;

FIG. 6 is a circuit diagram of a touchscreen controller such as the one of FIG. 4;

FIGS. 6A-6D are fractional detailed schematics of the circuit diagram shown in FIG. 6.

FIG. 7 is a block diagram illustrating a typical configuration for a computer system having multiple touchscreen monitors;

FIG. 8 is a block diagram illustrating an alternate configuration for a computer system having multiple touchscreen monitors;

FIGS. 9A-9B are a flow diagram illustrating exemplary logic implemented by a controller for a multi-port input device, such as a multi-port touchscreen controller, to automatically determine which input/output port is connected to a computer such as the one in FIG. 1;

FIG. 10A is a flow diagram illustrating exemplary logic implemented in a computer such as the one shown in FIG. 1 to perform an initial factory calibration process;

FIG. 10B is a flow diagram illustrating exemplary logic implemented in a computer such as the one shown in FIG. 1 to perform a user calibration process;

FIG. 11 is a flow diagram illustrating exemplary logic implemented within a computer system such as the one in FIG. 1 for initializing a data-correction sub-process;

FIG. 12 is a flow diagram illustrating exemplary logic implemented within a computer system such as the one in FIG. 1 that functions as a data-correction sub-process, applying data corrections to the raw touch-position data to derive calibrated touch-position data;

FIG. 13 is an exemplary block diagram illustrating one possible organization for various types of information that might be stored in a variably-sized storage system for non-volatile memory; and

FIG. 14 is a flow diagram illustrating exemplary logic for a variably-sized storage system for non-volatile memory.

### DETAILED DESCRIPTION

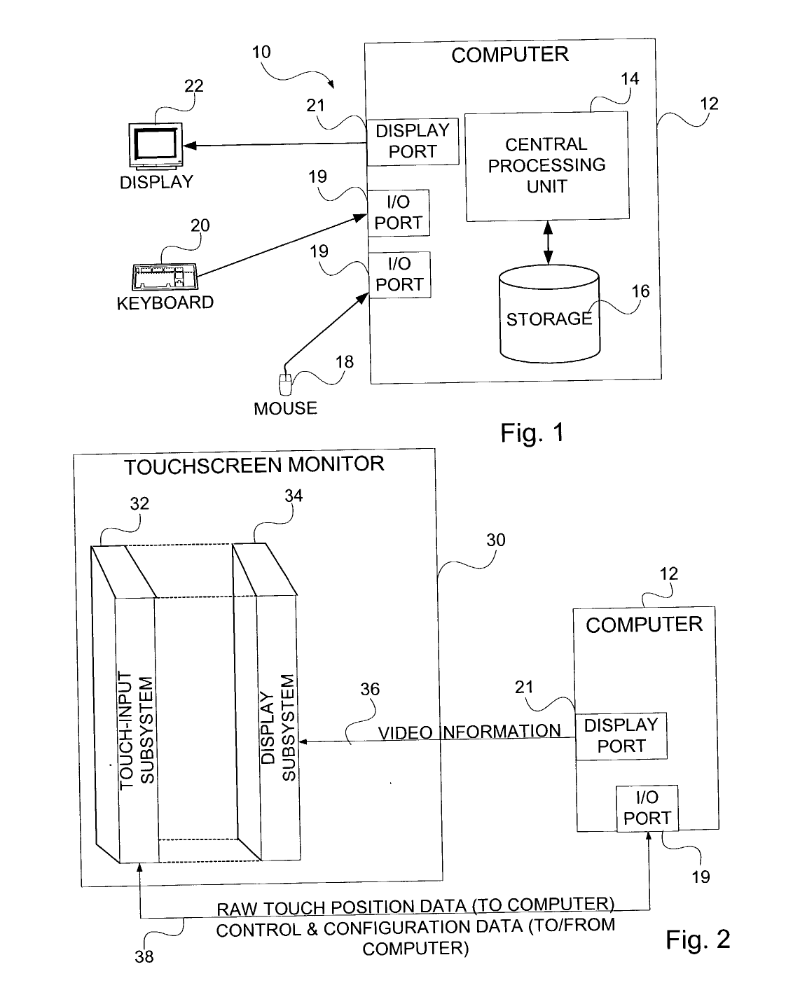

An improved touchscreen monitor is shown and described herein. Referring now to the drawings wherein the showings are for purposes of illustrating preferred embodiments of the present invention only, and not for purposes of limiting the same, FIG. 1 is a block diagram of an exemplary computer system 10. Computer systems, such as the one shown in FIG. 1, generally include a computer 12 that includes a central processing unit 14 and storage facilities 16 for storing programs and data. The computer system 10 includes input device(s), such as a mouse 18 and a keyboard 20 which are connected to the computer 12 via input/output ports 19. The computer system 10 also includes an output display device, such as a cathode ray tube (CRT) or flat-panel monitor 22 that is connected to the computer 12 via a display port 21. It will be appreciated that the computer system 10 shown in FIG. 1 is intended merely as an illustrative example and that other configurations can be used. For example, the computer system 10 may include additional peripheral (input/output) devices, such as a light pen and/or a printer.

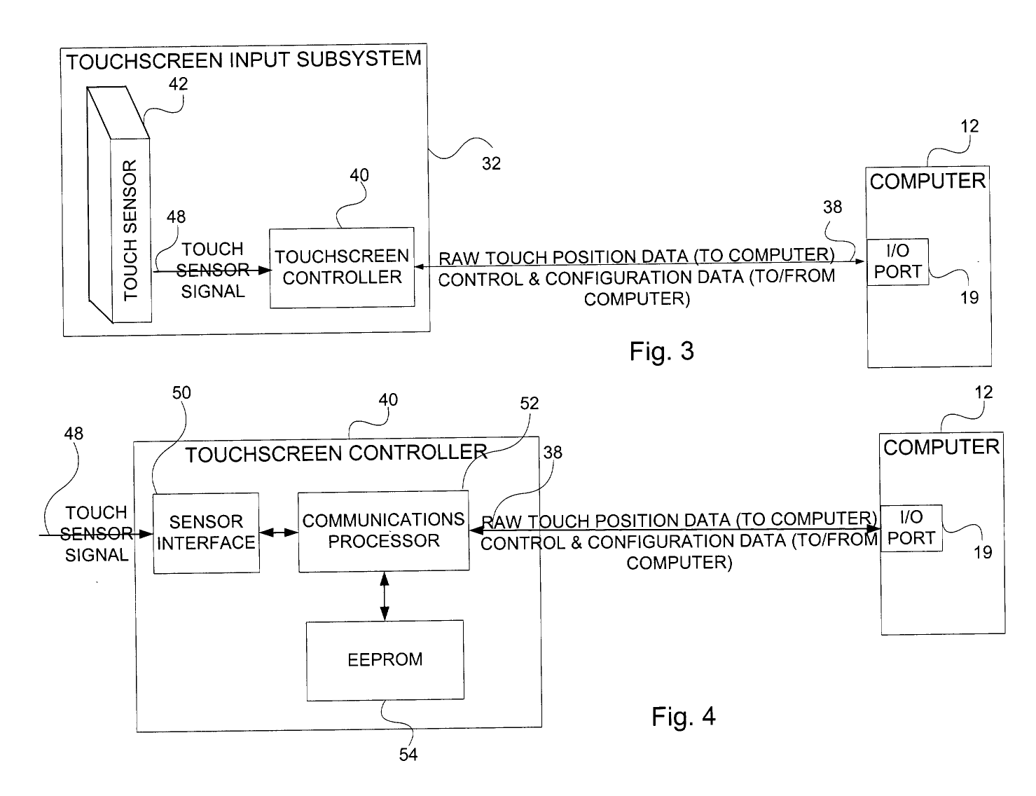

The computer system 10 shown in FIG. 1 may include a touchscreen monitor 30 such as the one shown in FIG. 2. Touchscreen monitors 30 are unique in that they physically combine an output device capable of displaying an image, such as a CRT or liquid crystal display (LCD) flat-panel computer display 34, with a touch-input subsystem 32 (shown in FIG. 3) capable of sensing touch and determining the location of the touch within a defined area. In general, the display subsystem 34 and touch-input subsystem 32 share little or no common electrical circuitry, but they are joined mechanically such that the touch sensor 42 is mounted parallel to and in close proximity to the surface of the display subsystem 34 on which the image is formed. Furthermore, the area of the touch sensor 42 that is responsive to touch is most often similar in size to and closely aligned with the area of the display system capable of displaying an image. In some cases the area of the touch sensor 42 that is responsive to touch is larger than the monitor to provide for additional input-button functionality.

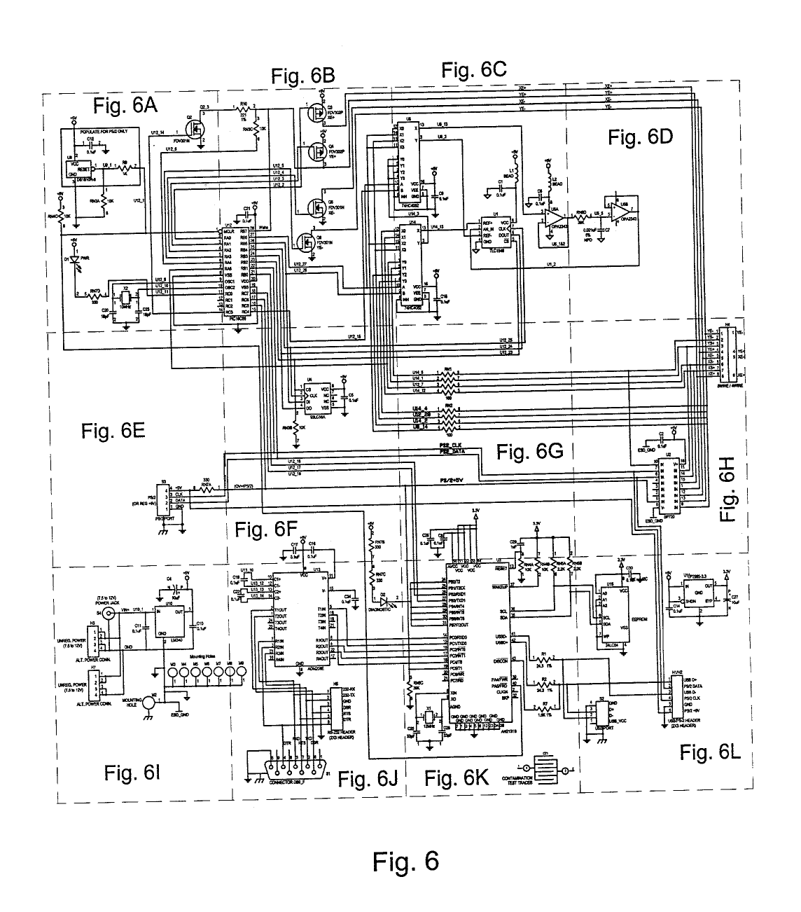

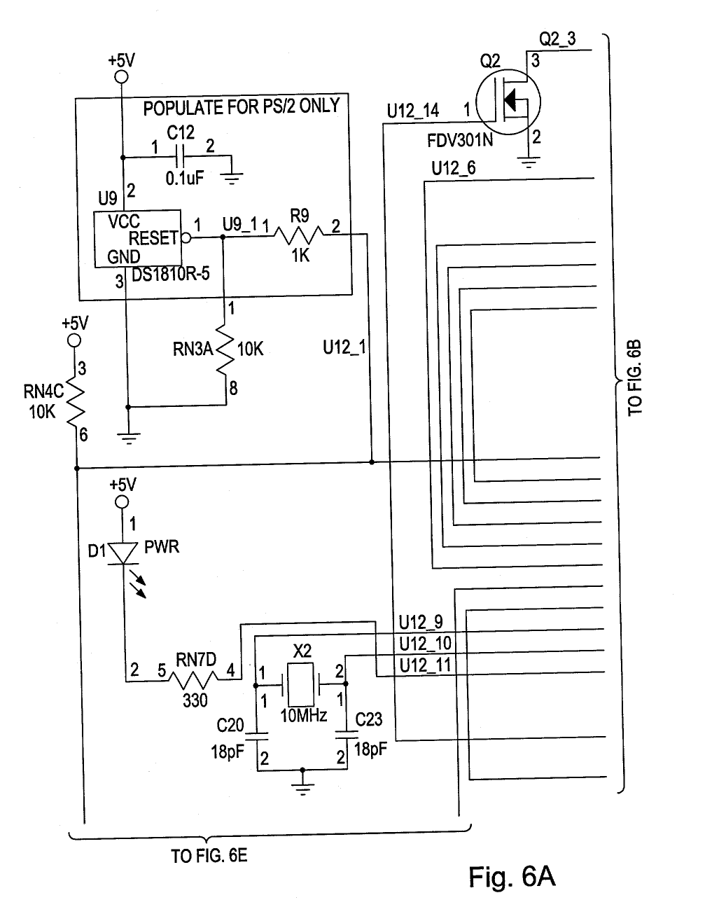

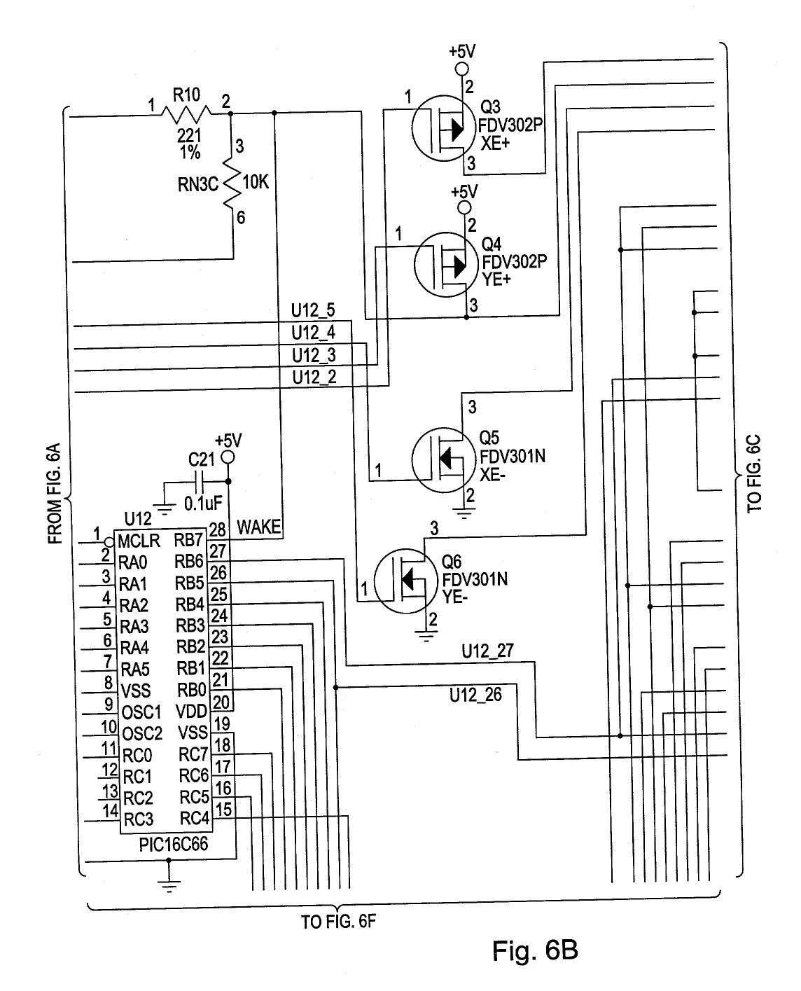

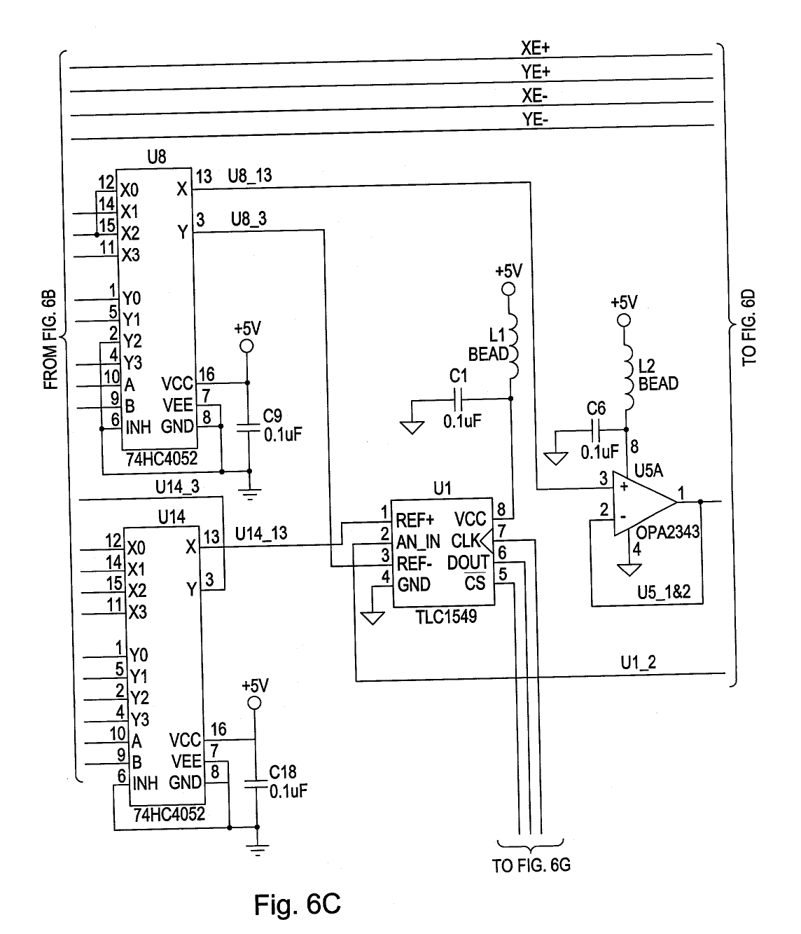

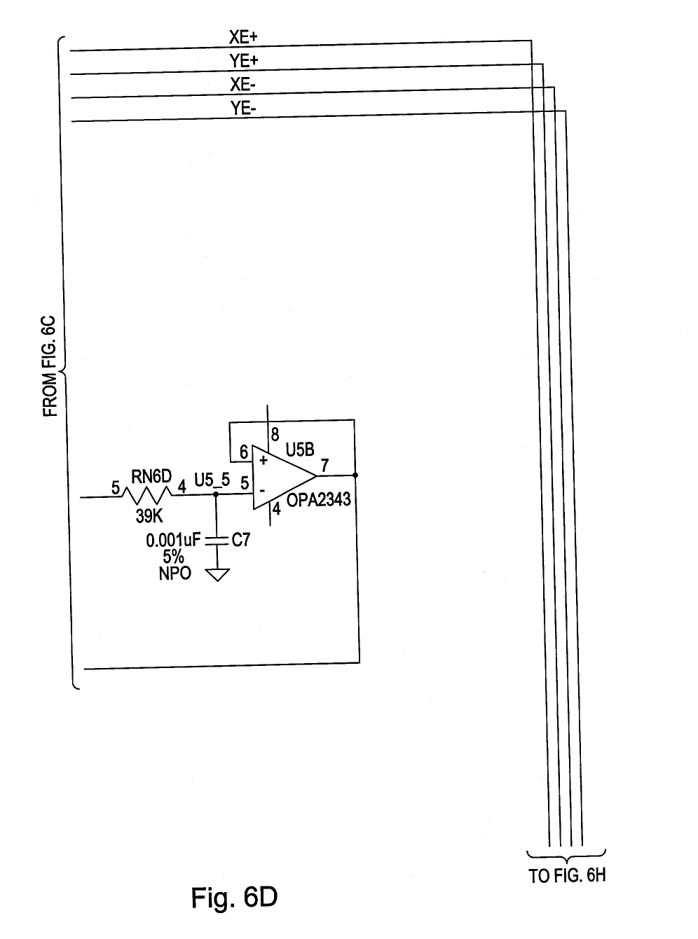

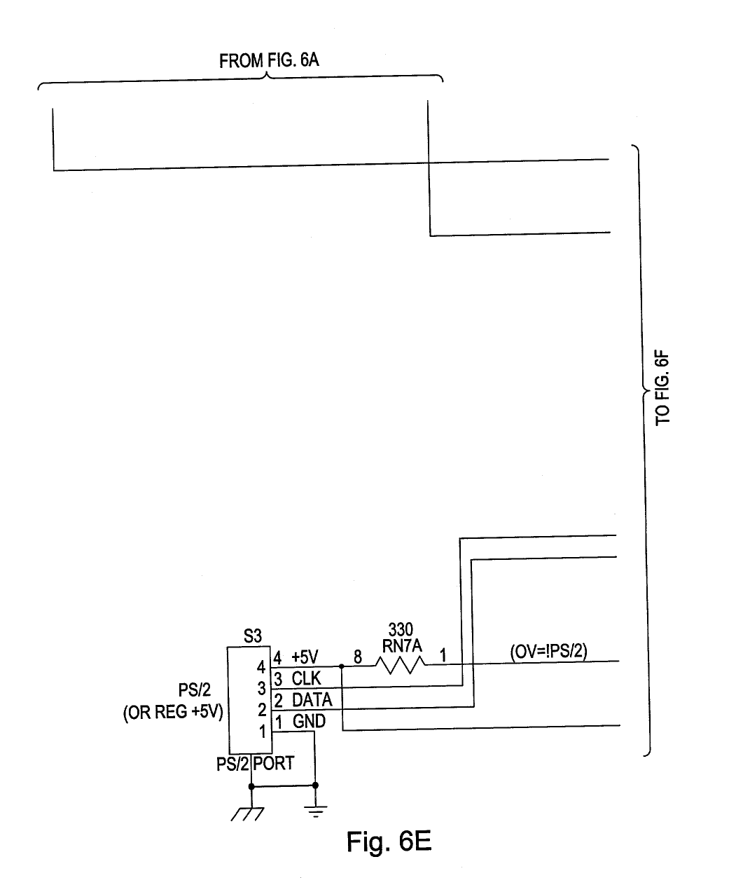

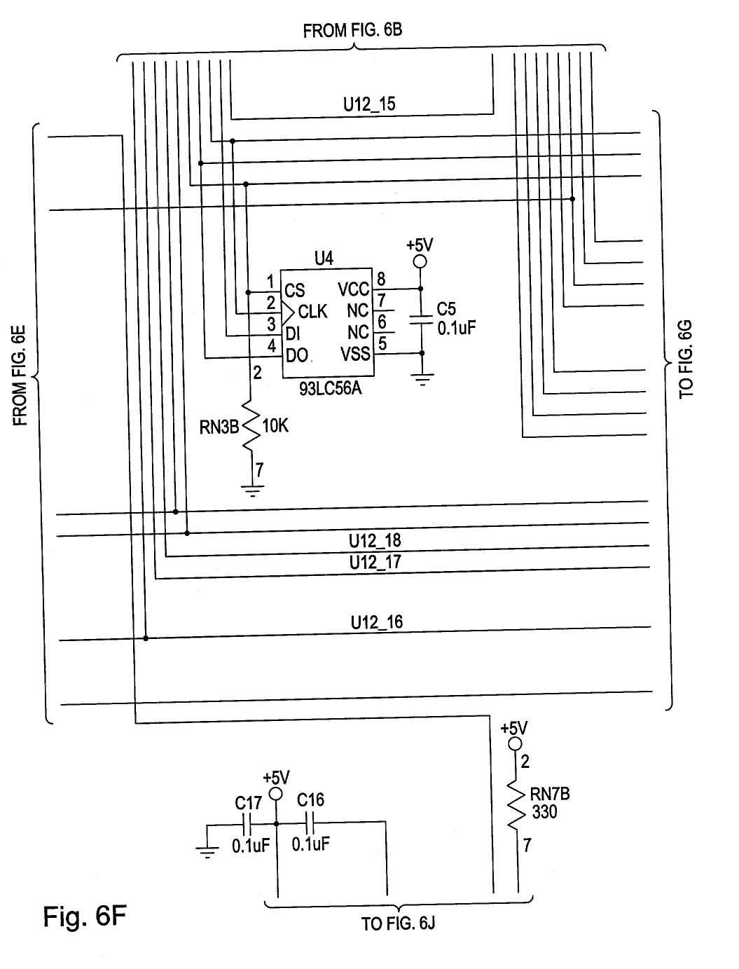

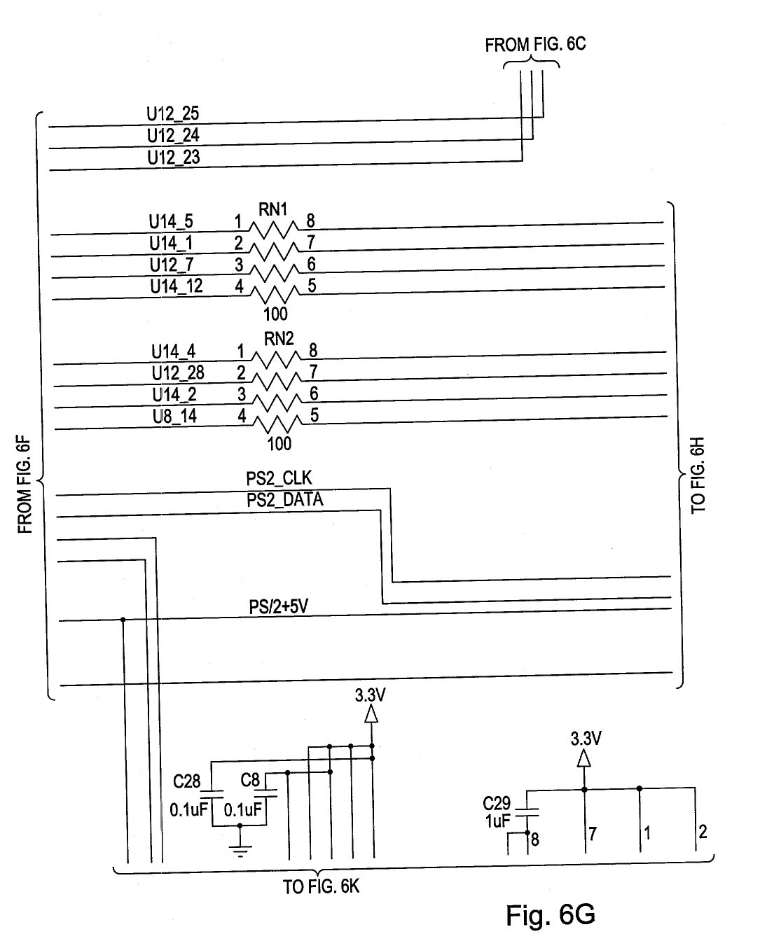

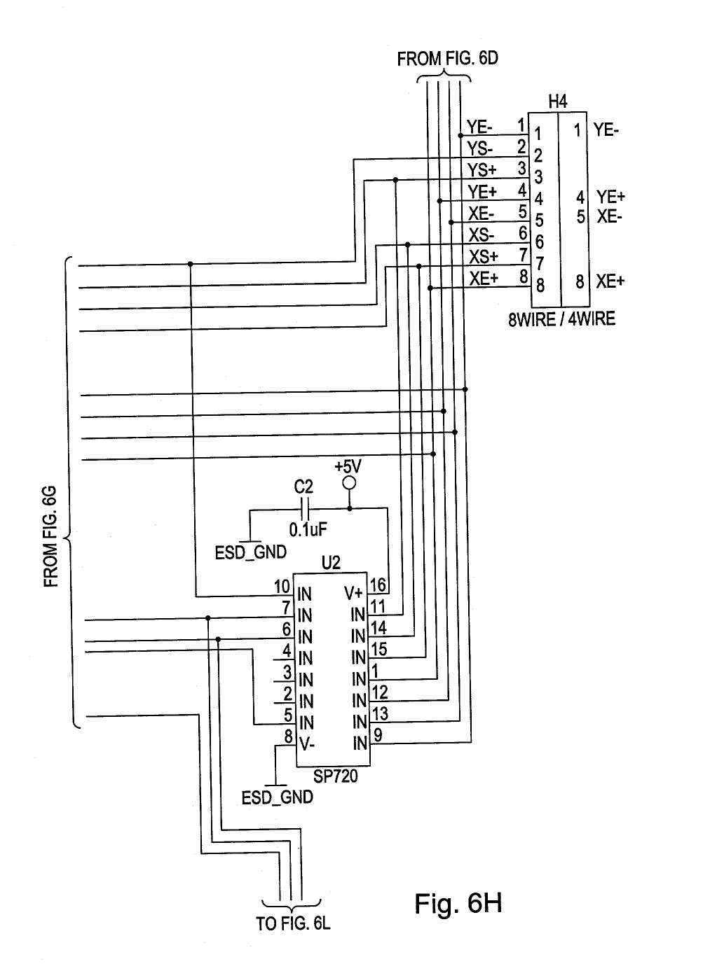

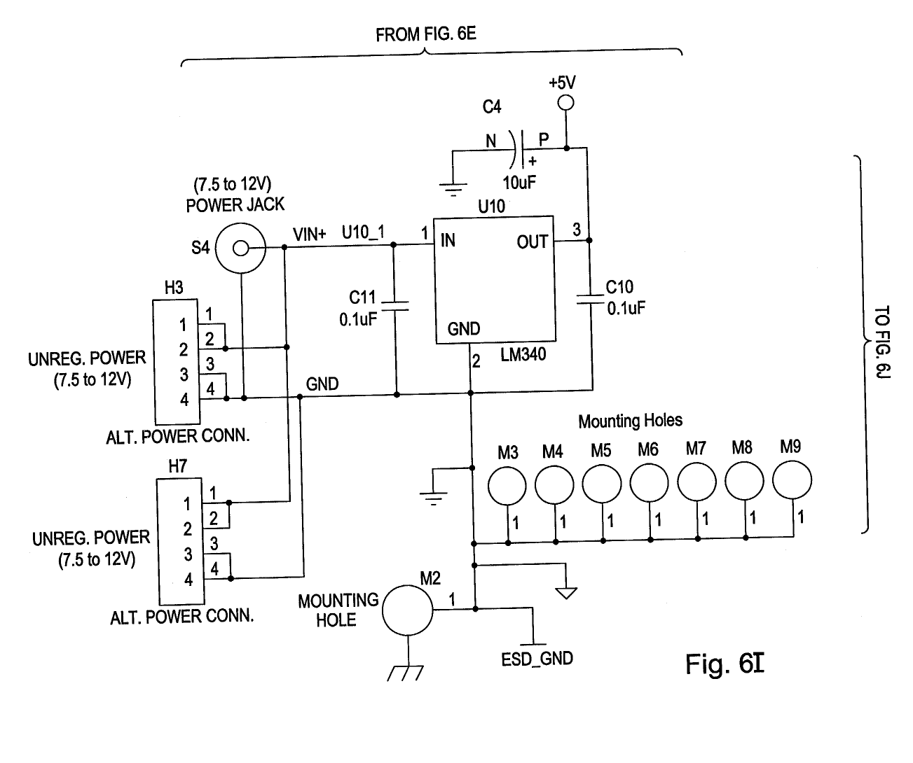

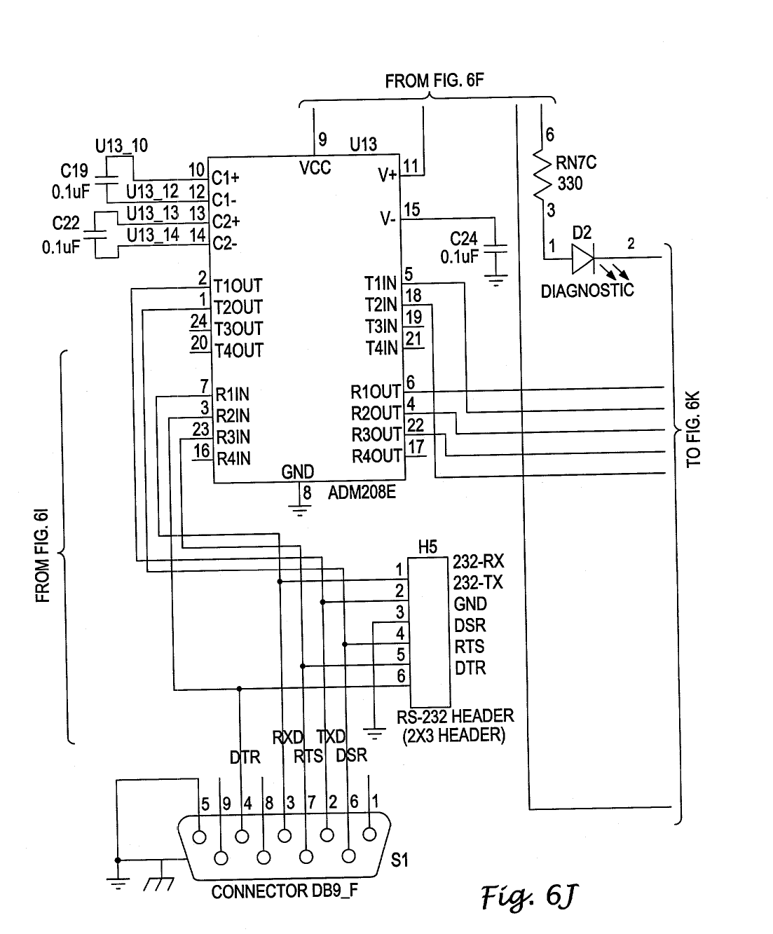

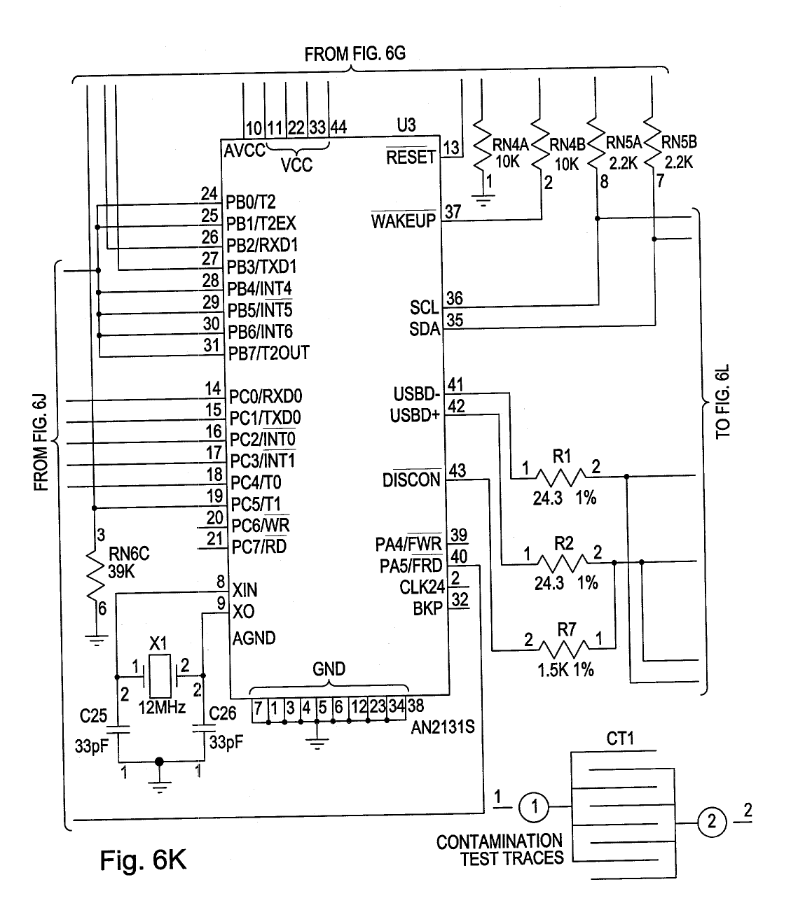

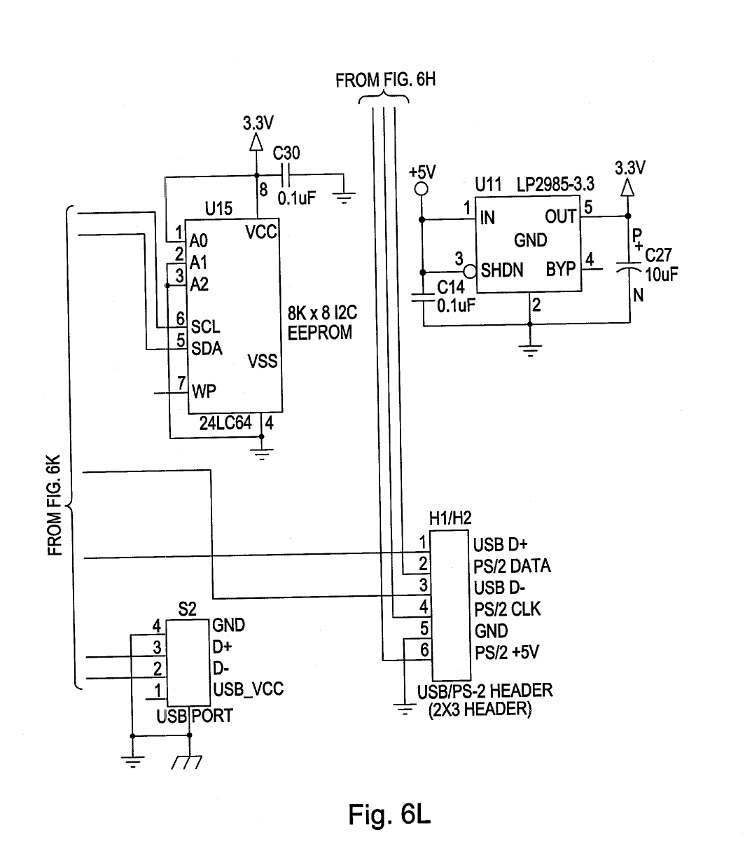

Several technologies exist for determining the location touched on a touch sensor, including but not limited to resistive, capacitive and surface acoustic wave technologies. In most cases, the output of the touch sensor 42 is some type of analog signal 48 that corresponds to the location of the touch, and additional electrical circuitry is required to convert the raw analog signal into a usable digital message containing location information. That interface circuitry (termed a “touchscreen controller” 40 and shown as a block diagram in FIG. 4 and as a schematic in FIG. 6) is usually mounted in close proximity to the touch sensor 42, most often within or on a non-display surface of the touchscreen monitor 30. Generally, separate connectors and/or cables are provided for receiving from the computer 12 the video information signal 36 to be displayed and for providing to the computer 12 the raw touch-position data signal 38 that indicates the location that was touched. Control and configuration data 38 is also transmitted bi-directionally between the computer 12 and the touchscreen controller 40.

As shown in FIG. 3, the touch sensor 42 is in communication with the touchscreen controller 40. An exemplary block diagram of the touchscreen controller is shown in FIG. 4 and an exemplary circuit diagram of the touchscreen controller 40 is shown in FIG. 6. The touchscreen controller 40 includes a sensor interface 50 that receives signals 48 from the touch sensor 42. When a user touches the active surface of the touchscreen monitor 30, the touch sensor 42 sends a touch sensor signal 48 to the sensor interface 50 indicating the location of the touchscreen that was touched. In prior art systems the sensor interface 50 forwards this information directly to the computer 12. As shown in FIG. 4, the signal may be sent to an intermediary communications processor 52. The communications processor 52 can include logic as described herein to perform various functions, such as automatically determining an active input/output port to be used for communication with a host computer, converting protocols, etc. The touchscreen controller 40 also includes non-volatile memory (e.g., EEPROM) 54 for storing data, such as calibration data and a unique identification code, such as a serial number, for simplified use in systems with multiple touchscreen monitors.

A computer input device, such as a touch-input subsystem 32, may be connected to a computer system 10 using one of a plurality of interconnection technologies, such as USB and serial. Logic may be executed in the touchscreen controller 40 to automatically determine the type of connection used without user intervention. While the description herein is directed to a touch-input subsystem 32, it will be appreciated that the methodology could be applied to a wide variety of computer input devices.

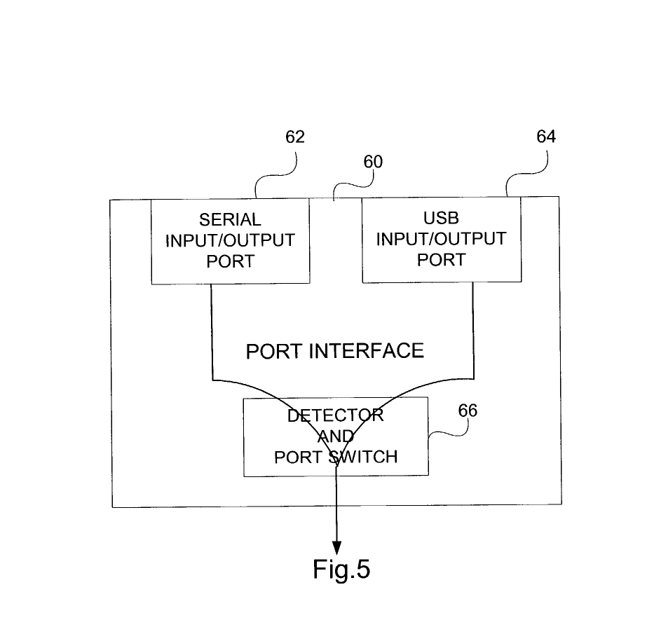

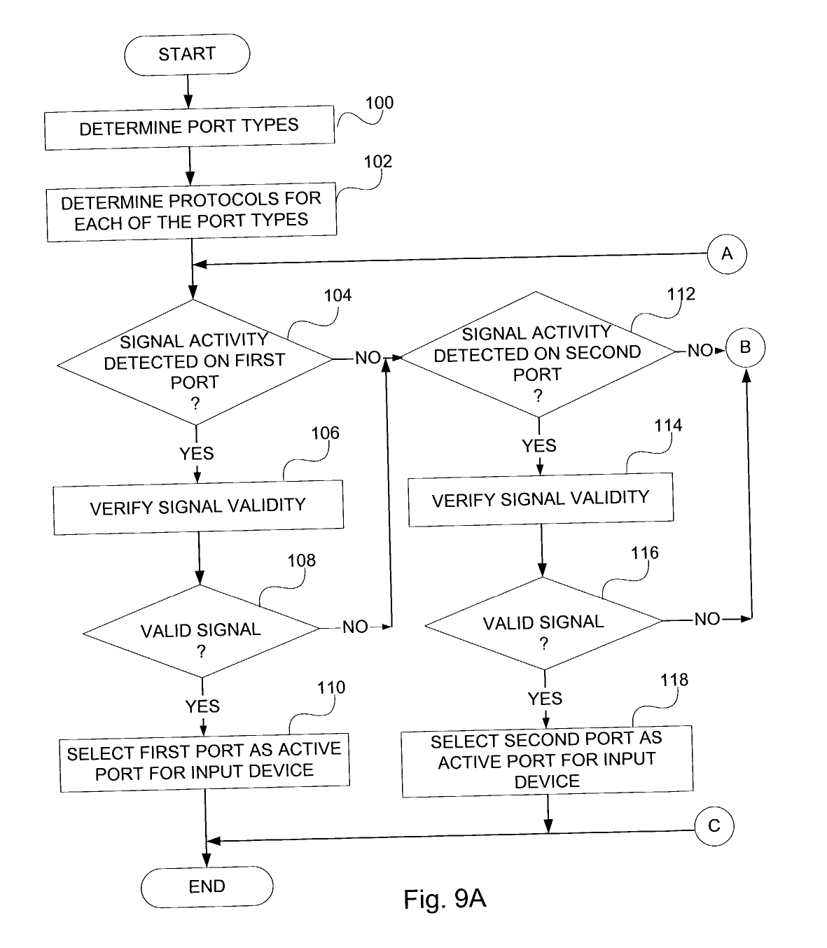

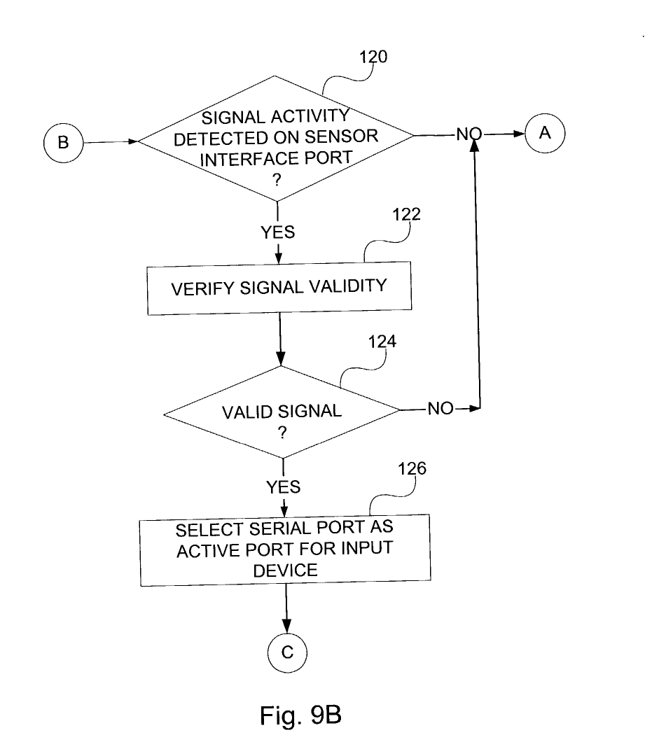

A microprocessor or other circuitry can provide connectivity for multiple communication modes through separate input/output ports in a communications processor 52. For example, as shown in FIG. 5, an input/output port interface 60, may reside in communications processor 52 in the touchscreen monitor 30, and it may include different types of input/output ports, e.g., a serial input/output port 62 and a USB input/output port 64. Signals from one of the input/output ports (serial input/output port 62 or USB input/output port 64) go through a detector and port switch 66 for onward routing to and from a sensor interface 50. The detector 66 includes logic, such as that shown in FIGS. 9A-9B and described later, for automatically determining which of the input/output ports 62 or 64 is connected to a host computer 12. In exemplary embodiments, the logic of FIGS. 9A-9B (the detector and port-switch logic) is implemented in the communications processor 52.

When the input device interface first receives power, and at other times as appropriate, each of the input/output ports 62 and 64, is scanned for electrical signals that are consistent with activity on that input/output port, and when an input/output port is identified that can provide a valid communication channel to the computer 12, scanning is ended. The input/output port that has been identified will be used for subsequent communication with the host computer 12 until a predefined event, such as the removal and restoration of the external source of power, signifies an appropriate time to re-start the input/output port scanning process. Information that will be considered as input for the computer 12 will be sent to the selected input/output port, 62 or 64, for onward forwarding to computer 12, and commands to control the input device will be received from computer 12 through that input/output port, 62 or 64. This allows an input device, such as a touch-input subsystem 32, to be connected to a computer 12 utilizing any of the multiple communication modes provided, with the communication mode being automatically selected without user intervention.

In some cases it may be difficult or impossible to determine when a valid communication channel exists on a serial input/output port 62 where the host computer 12 does not utilize a “plug-and-play” or similar character sequence to query an input device, instead waiting passively for input from the input device. In these cases the input/output port to be used can be assumed to be the serial input/output port 62 when a signal is received from the touch sensor interface 50 for onward routing to the host computer 12 and the active input/output port has not otherwise been automatically detected by the logic of FIGS. 9A-9B (the detector and port-switch logic).

Exemplary logic for automatically selecting the connection type is shown in the flow diagram of FIGS. 9A-9B. The logic shown in FIGS. 9A-9B is executed when the touchscreen controller receives power. The logic moves from a start block to block 100 where the input/output port types are determined, typically by examining configuration data stored in the EEPROM 54 at the time of manufacture. For example, the input device controller may include a serial input/output port 62 and a USB input/output port 64 as shown in FIG. 5.

Protocols are determined at block 102 for the available input/output ports, typically again by examining configuration data stored in the EEPROM 54 at the time of manufacture. This is used to determine the type of signal activity that is valid for a given type of signal, either by the lines on which the signal is detected or by the format of the signal or both.

The input/output ports are then continually scanned for a valid signal. If the computer system 12 includes serial port “plug-and-play” functionality, a signal may be received from the computer 12 providing activity on the serial input/output port (e.g., serial input/output port 62) that is readily detectable for determination that the serial input/output port 62 is to be used for communication with the computer 12. If a signal is detected on the first input/output port (yes in decision block 104), the logic proceeds to block 106 to determine if the signal is a valid signal for the first input/output port type. Activity that defines a valid signal for the first input/output port type is defined in block 102. If the signal is a valid signal for the first input/output port type (yes in decision block 108), the logic proceeds to block 110 where the first input/output port is selected as the active input/output port for communication with the computer 12.

If no activity is detected on the first input/output port (no in decision block 104) or activity is detected on the first input/output port, but the activity is not indicative of a valid signal for the first input/output port type (no in decision block 108), the logic moves to decision block 112 to scan for signal activity on the second input/output port. If activity is detected on the second input/output port (yes in decision block 112), the logic moves to block 114 to determine if the signal is a valid signal for the second input/output port type. If the signal is a valid signal for the second input/output port type (yes in decision block 116), the logic proceeds to block 118 where the second input/output port is selected as the active input/output port for communication with the computer 12.

If no activity is detected on the second input/output port (no in decision block 112) or activity is detected on the second input/output port, but the activity is not indicative of a valid signal for the second input/output port type (no in decision block 116), the logic moves to decision block 120 (FIG. 9B) to scan for signal activity on the sensor interface port. As described above, if no activity is found on either of the first two input/output ports before a signal is received from the touch sensor interface 50, the active input/output port is assumed to be the serial input/output port. This is especially useful in computer systems that do not have “plug-and-play” functionality. If activity is detected on the sensor interface port (yes in decision block 120), the logic moves to block 122 to determine if the signal is a valid signal for the sensor interface port. If the signal is a valid signal for the sensor interface port (yes in decision block 124), the logic proceeds to block 126 where the serial input/output port is selected as the active input/output port for communication with the computer 12.

If no activity is detected on the sensor interface port (no in decision block 120) or activity is detected on the sensor interface port, but the activity is not indicative of a valid signal for the sensor interface port (no in decision block 124), the logic returns to decision block 104 (FIG. 9A) to scan for signal activity again, starting over with the first input/output port. The logic of blocks 104-124 is repeated until a valid signal is detected on the first input/output port (block 108) or the second input/output port (block 116) or on the Sensor Interface port (block 124). Once a valid signal is detected, the active input/output port for the touchscreen controller is selected (block 110, 118 or 126), and the logic of FIGS. 9A-9B ends. The logic of FIGS. 9A-9B is directed to an input device such as a touchscreen controller having two input/output ports of different types, with the possibility that one of the input/output ports can be valid for communication with a host computer 12, even when there is no initial signal activity. It will be appreciated that other configurations are possible, e.g., more than one input/output port for one or more of the types and/or more than two input/output port types.

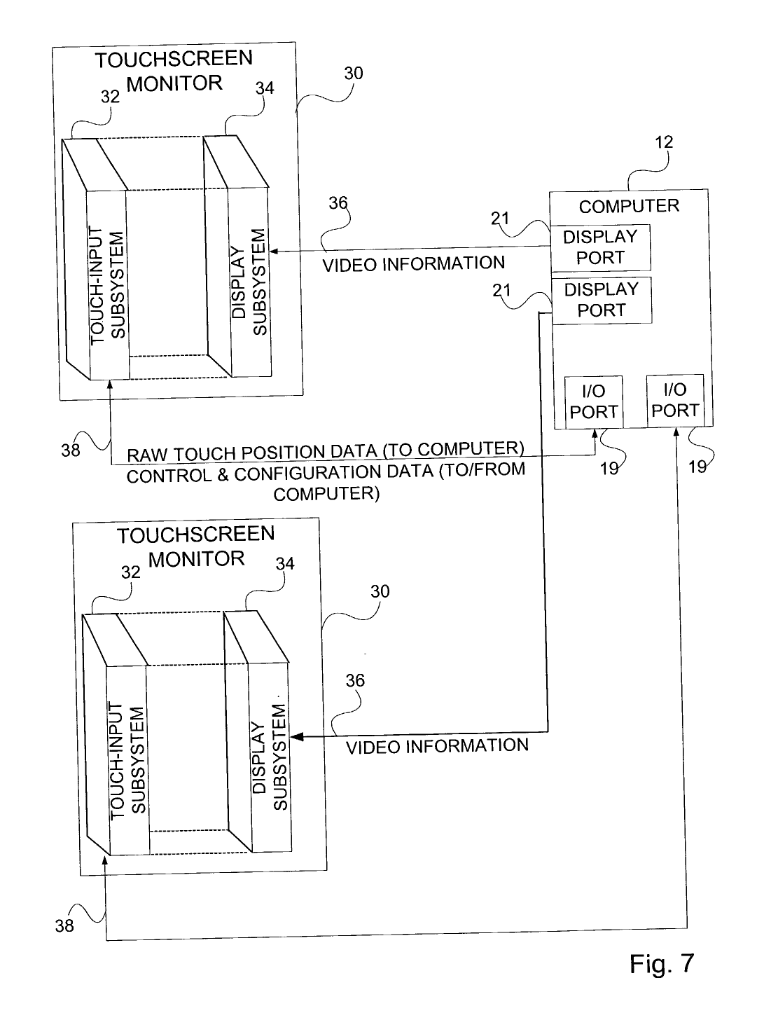

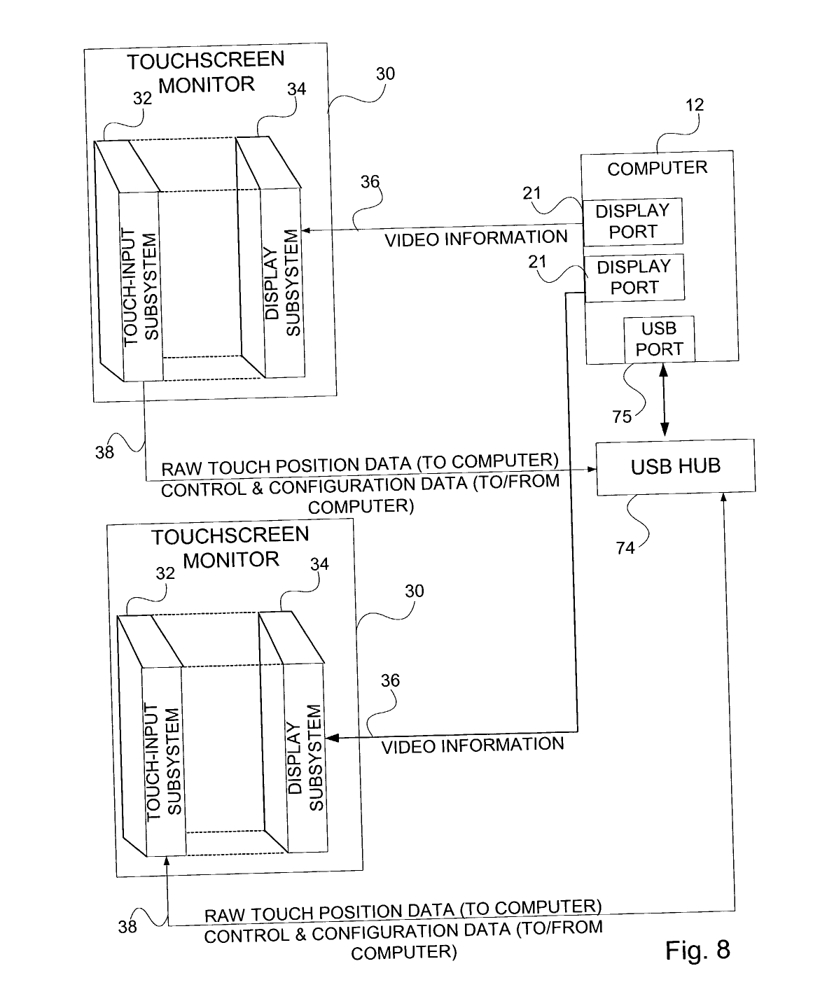

Some applications (for example, a point-of-sale system, as often used in fast-food restaurants, or a litigation-support system, as used in a courtroom setting where various participants, e.g., plaintiff's attorney, defendant's attorney and judge each have their own monitor) may require multiple touchscreen monitors 30 to be connected to a single computer 12, each of which would require a dedicated serial input/output port. FIG. 7 illustrates a typical arrangement for connecting two touchscreen monitors to a single computer 12. USB connections allow a great many devices to be connected to a single USB input/output port 75 with simple port-sharing devices called USB hubs 74. FIG. 8 illustrates a typical arrangement where two touchscreen monitors are connected to a single computer in conjunction with a USB hub 74.

The problem of reliably determining which input subsystem is associated with a particular display port 21 on computer 12 can be circumvented by utilizing unique identifiers for each touchscreen that are independent of the arbitrary codes assigned when USB devices are enumerated or re-enumerated. Specifically, each input device controller 40 includes a unique identification code, most typically a serial number. Within the input device driver software on computers utilizing multiple touchscreen monitors, this unique identification code is read and placed into a table that is maintained for the purpose of associating this unique identification code with a specific display port 21. This allows the various USB devices to be re-enumerated without affecting the touch-input subsystem to display port associations.

A method for uniquely associating the calibration data for a particular touch-input subsystem with a touchscreen monitor as a singular replaceable component subsystem provides for a very accurate factory calibration procedure, while permitting a simplified local user calibration procedure that can be performed by the actual user to allow data-correction adjustments that are specific to a particular installation and to recover from errors during the local user calibration procedure. The methodology allows for very accurate calibration data to be determined at the time of manufacture (termed “factory calibration data”) utilizing as many calibration points as needed to overcome non-linearities in the touch sensor and achieve the desired touch-input subsystem accuracy. The factory calibration data is subsequently utilized by a first data-correction sub-procedure during routine touchscreen monitor usage. The method allows the user of the touchscreen monitor to also perform a subsequent local user calibration procedure to derive additional independent calibration data (termed “user calibration data”) for the purpose of correcting for installation-dependent factors. The local user calibration procedure is independent of the initial factory calibration procedure, and the local user calibration procedure is optionally simplified to utilize fewer calibration points than the initial factory calibration procedure. The user calibration data is utilized by a second independent data-correction sub-procedure during routine touchscreen monitor usage. The methodology allows the touchscreen monitor user to easily reset the overall data-correction operation to that provided by the factory calibration data alone in the event of an error during the user calibration procedure or in the event of other need. The method also allows the touchscreen monitor to be replaced without the need for the user to perform a new local user calibration procedure, while retaining any installation-dependent data-correction parameters determined to be necessary through an earlier local user calibration procedure.

The touchscreen controller 40 provides raw touch-position data 38 that must be subjected to a data-correction process to derive actual screen-location data (termed “calibrated touch-position data”). The calibration data from the initial factory calibration procedure, which provides the required data-correction parameters, is stored within a non-volatile memory device on the input device controller, e.g., EEPROM 54.

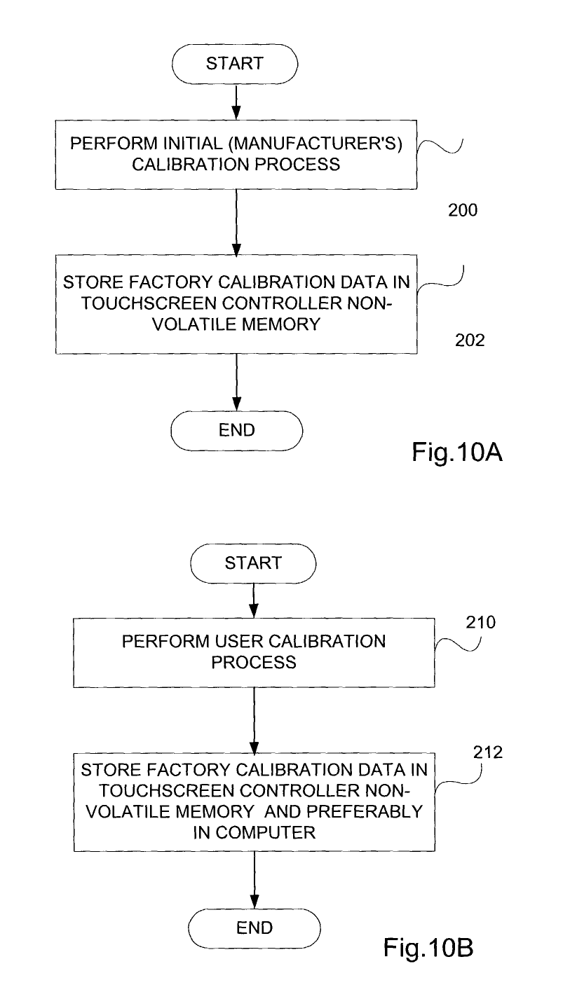

FIG. 10A is a flow diagram illustrating exemplary logic for performing initial factory calibration procedure. The logic of FIG. 10A moves from a start block to block 200 where an initial factory calibration procedure is performed during the manufacturing process, and the calibration data, termed “factory calibration data,” is stored in the touchscreen controller's non-volatile memory 54 at block 202. By storing standardized factory calibration data in a non-volatile memory device within a touchscreen monitor 30, a touchscreen monitor 30 that has failed after installation can be replaced in the field without the need for additional calibration or re-calibration steps.

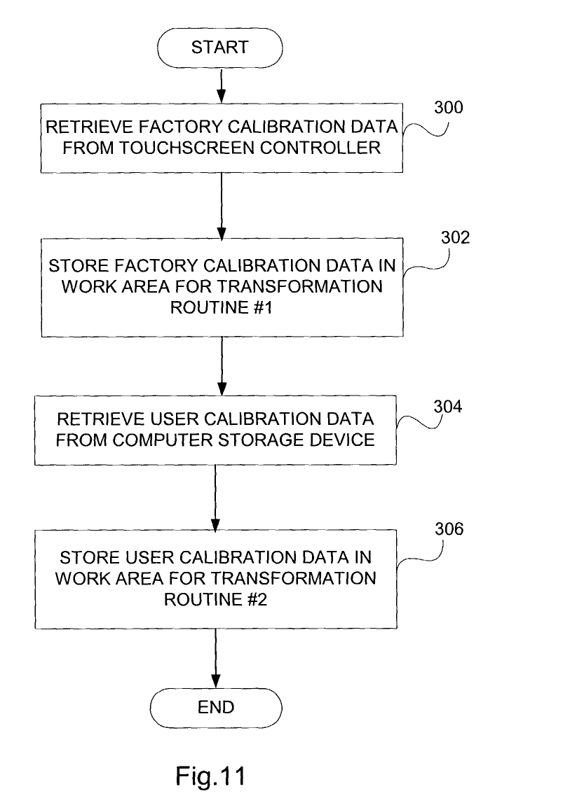

Some touchscreen monitor installations may require different data-correction processing than provided by the factory calibration data, typically to correct for installation-related parallax errors or when the display subsystem is being operated at non-standard resolution values. Typically the touchscreen monitor user will be provided with a calibration program that is similar to the one utilized during initial manufacturing (see logic of FIG. 11), but possibly with fewer calibration points as any need for sophisticated linearization will typically be accommodated with the initial factory calibration process during manufacturing, and it will only be scaling and offset errors that must be corrected through a local user calibration process.

FIG. 10B is a flow diagram illustrating exemplary logic for performing such a user calibration process. The logic of FIG. 10B moves from a start block to block 210 where a user calibration process is performed to derive additional calibration as described above. The logic then moves to block 212 where the additional calibration data termed “user calibration data” derived in the user calibration process of block 210 is stored within the computer 12 for subsequent usage by a second data-correction sub-process that is independent of the data-correction process that utilizes the factory calibration data.

The factory and user calibration data will typically be used in a multi-step data-correction sub-process that converts the raw touch-position data to calibrated touch-position data, with such data-correction sub-process preferably contained in software device driver logic that operates on the computer 12. The data-correction procedure will typically consist of two separate processes, an initialization process that is performed each time a computer is started, and a data-correction sub-process that is repeatedly called into action in response to the receipt of raw touch-position data from the touch-input subsystem 32 through an input/output port 19.

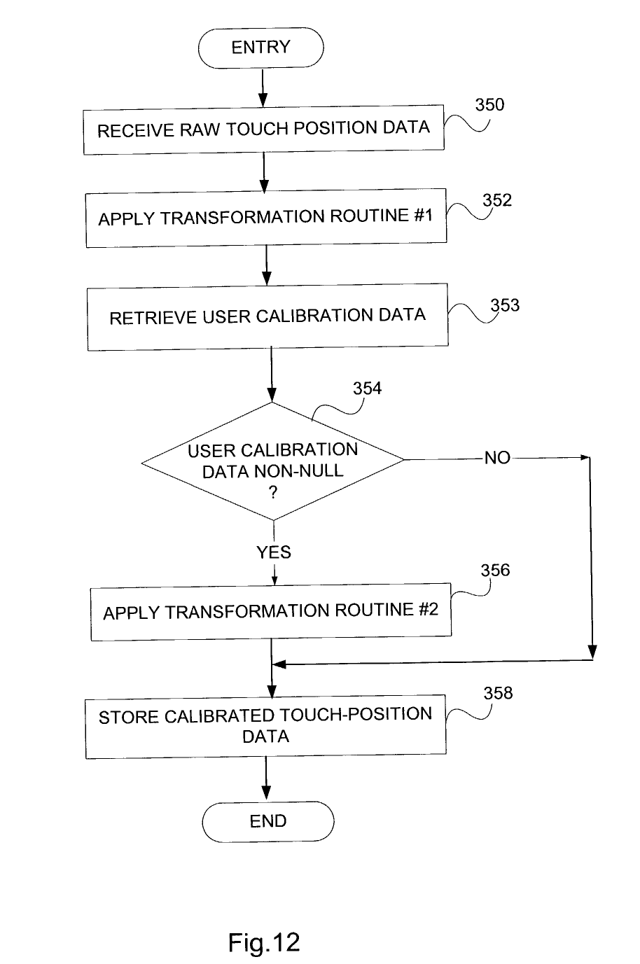

Exemplary logic for initializing the data-correction sub-process is shown in the flow diagram of FIG. 11, which is executed when the computer starts after initially receiving power, when re-booted or at other times as appropriate. The logic moves from a start block to block 300 where the factory calibration data derived at the time of manufacturing (and stored at block 202 of FIG. 10A) is retrieved from the touchscreen controller's non-volatile memory 54. At block 302 the factory calibration data is stored within an area of memory in the computer 12 that will be easily accessible by the data-correction sub-process logic shown in FIG. 12. Next, the user calibration data, if any, (that was stored at block 212 of FIG. 10B) is retrieved from the computer's storage device 16 at block 304, and it is also stored at block 306 within an area of memory in the computer 12 that will be easily accessible by the data-correction sub-process logic. It should be noted that the default values for the user calibration data, stored when the device driver software is initially installed on the computer, signify that no user calibration data has been stored, and thus the default is that there will be no data correction based on user calibration data unless the user explicitly engages in a local user calibration process such as the one exemplified in FIG. 10B.

Exemplary logic for the data-correction sub-process that converts the raw touch-position data into calibrated touch-position data is shown in the flow diagram of FIG. 12. It should be noted that this logic is preferably in the form of an “interrupt service routine,” meaning it is available for execution at all times, but it only receives control when triggered by some external event, which in this case is specifically the receipt of raw touch-position data 38 by the computer 12 from the touch-input subsystem 32. The logic for receiving input device data, such as raw touch-position data 38, through an input/output port 19 and invoking device driver software is typically incorporated into the operating system for the computer 12. In the instant case, receipt of raw touch-position data 38 from a touch-input subsystem 32 through an input/output port 19 on the computer 12 will cause the operating system for the computer to place that data in an area accessible to the device driver software and then transfer control to the entry point for the data-correction sub-process, the logic of which is shown in FIG. 12.

The logic of FIG. 12 moves from the entry block to block 350 which receives the raw touch-position data from the area where it was placed by the logic that invoked the data-correction sub-process. Standard matrix transformation and interpolation techniques are utilized at block 352 to normalize the raw touch-position data into a format recognized by the operating system for the computer 12 as an appropriate indication for the position on the touch sensor that was actuated by the user, as determined by the factory calibration data made accessible to the data-correction sub-process at block 302.

The logic moves to decision block 354 in which the user calibration data made available at block 306 and retrieved in block 353 is tested for a non-null correction value. If the test determines that the value is null (no at decision block 354), this indicates that no user calibration data has been stored to modify the intermediate touch-position data resulting from application of the factory calibration data in the data-correction sub-process at block 352, and the logic moves to block 358 where the resulting touch-position data is stored in a location accessible to the operating system for the computer, and then control is returned at the end block to the logic which invoked the data-correction sub-process.

If a non-null value for the user calibration data is detected (yes at decision block 354), the logic moves to block 356 where the data resulting from the data-correction process at block 352 is subjected to a second data-correction process to apply the corrections determined through the local user calibration process to be appropriate. The intermediate touch-position data resulting from the data-correction process at block 352, along with the second possible data-correction process at block 356, is termed “calibrated touch-position data,” and it is stored in a location accessible to the operating system for the computer at block 358, and then control is returned at the end block to the logic which invoked the data-correction sub-process.

It should be noted that the logic of FIG. 12 could have been arranged such that the data-correction process applied at block 356 was applied as an alternative to the data-correction process applied at block 352, however it is preferable that this second data-correction process be performed subsequent to, rather than as a replacement for, the first data-correction process. The reasons are threefold: first, this logical arrangement is necessary to allow one touchscreen monitor to be replaced with another without requiring a new local user calibration process. Second, it is trivial to reset the calibration data for the second data-correction process to null values to restore the original factory calibration values in the event of an error during the local user calibration process, without the need to separately save and restore factory calibration values. Third, this cascaded approach to the data-correction process, as opposed to a complete replacement for the factory calibration data derived during manufacturing, allows sophisticated multi-point linearizations that may have been included in the initial factory calibration process to be retained, while providing the user with a greatly simplified local user calibration process to correct for simple scaling and offset errors. Non-volatile memory devices, typically utilizing EEPROM or Flash technology, can be used to retain certain information within the touchscreen controller 40. In prior art systems, it is necessary to select a specific size for the non-volatile memory component 54 during the design phase and write the driver software to be specific to that size of memory component.

It is preferable that the logic of FIG. 12 be performed on the computer 12, but it could also be performed within the communications processor 52.

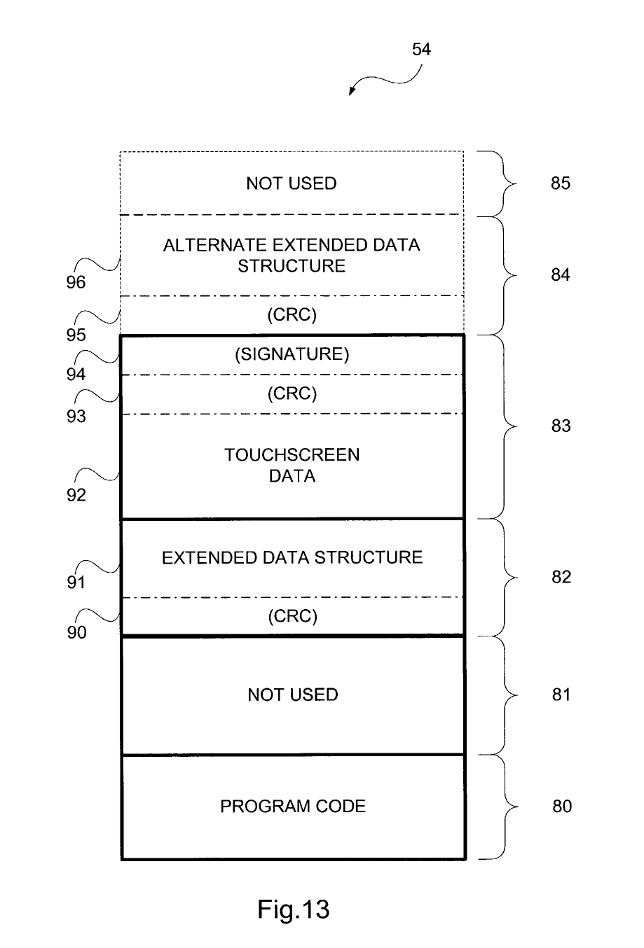

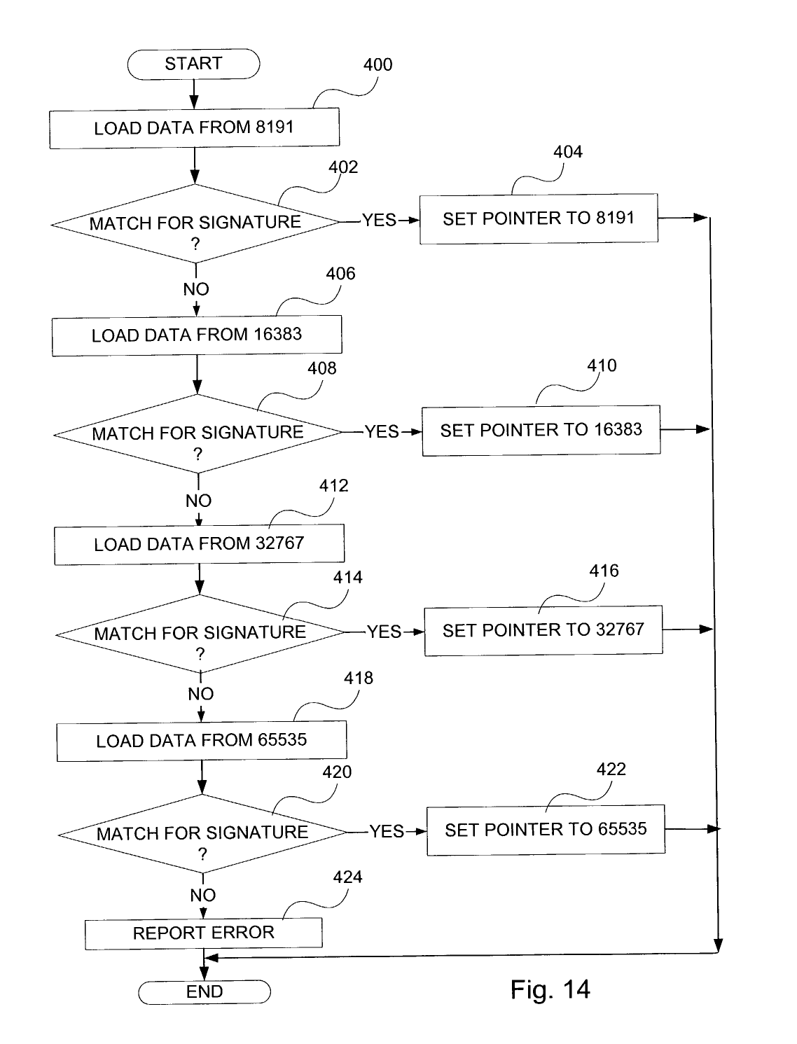

FIG. 13 illustrates a simplified block diagram showing the organization of the data stored within non-volatile memory device 54, and FIG. 14 illustrates exemplary logic for accessing data that has been stored in various sizes of non-volatile memory devices. The methodology described below provides for computer input device with local non-volatile storage capabilities that can use different size non-volatile memory devices, while maintaining forward and backward compatibility with the associated software drivers that write data to or read data from the non-volatile memory device and while maximizing the life expectancy of non-volatile memory devices when used in a computer input device and while simultaneously providing reliable detection of data corruption.

Referring to FIG. 13, the memory has been partitioned into 6 major regions 80-85. The area where the program code utilized by the communications processor 52 is stored 80 begins at the lowest address in the memory device and proceeds upward, taking as much space as required. This region is termed “program code.” Another region of the non-volatile memory device termed “touchscreen data” 83 is reserved for data used by the touchscreen controller 40, such as factory calibration data and a unique identifier. This region starts either at the actual top address of the memory device and proceeds down, or it starts at an address that would correspond to the top address for a smaller device and works down. The address range between the top of the program code and the bottom of the touchscreen data is divided into two regions: one is unused memory 81, and the other is an optional extended data structure area 82. It is possible for the extended data structure area 82 to have a size of zero.

Because non-volatile memory devices are typically sized as even multiples of 2, and there is a lower limit to the size of a memory device with practical applications, and there is an upper limit to the addressing capabilities of microprocessors that are typically used in input devices such as touchscreen controllers, there is a very limited set of addresses that are likely to correspond to the top of a non-volatile memory device, namely 8191, 16,383, 32,767 or 65,535. By writing a predefined bit pattern unlikely to be found in normal applications at the top of the touchscreen data structure 83, and by placing the top of the touchscreen data structure 83 at one of the limited number of addresses that correspond to the top of a non-volatile memory device (e.g., 8191, 16,383, 32,767 or 65,535), it is very simple to locate that structure, even if the actual device is larger than the location of the touchscreen data structure 83 would imply. Such a scheme allows larger memory devices to be used in place of a smaller device while simplifying software compatibility, provided the data structure for the touchscreen controller 83 is retained at one of the likely locations for the top of the memory device.

FIG. 13 shows two regions above the touchscreen data structure 83. These regions will only exist if the touchscreen data structure is located at one of the standard addresses that is below the actual top of the non-volatile memory device. If it exists, an alternate extended data area region 84 provides an alternative to region 82 for extended data structures, and the region 85 above the alternate extended data structure 84 would be unused. Normally only one extended data structure would be used, typically 82 if the touchscreen data structure 83 is at the actual top of the non-volatile memory device, or 84 if the touchscreen data structure 83 is not located at the physical top of the non-volatile memory device address range. It is possible to have two extended data structures, but it is preferred to have just one in the interests of simplicity.

Referring to FIG. 13, it can be seen that some of the regions previously described have been sub-divided. The touchscreen data area 83 includes a “signature” sub-area 94 that contains the unique bit pattern that allows positive identification of the touchscreen data structure. The limited set of predefined addresses will be searched for the fixed bit pattern “signature” to locate the top of the touchscreen data structure 83.

Within the touchscreen data structure there is also a validation sub-area 93 where validation information, preferably cyclical redundancy check data or similar checking mechanism data (“CRC”), can be stored to allow the integrity of the data stored within the touchscreen data area to be verified.

To increase operational speed, it may be desirable to copy the touchscreen data structure from the touchscreen controller 40 to a storage medium on the computer 12, such as a hard disk, and then access the data from that location, rather than accessing it from the touchscreen controller 40. The risk in doing this is that the monitor can be exchanged while the power is turned off, and this would not be detected unless validation steps are taken, such as re-reading the entire contents of the touchscreen data structure each time the computer 12 is started, which could be a time-consuming process. The CRC or checksum 93 provides a faster alternative to determine if a monitor has been replaced. Assuming the touchscreen data structure 83 contains a unique code, such as a serial number, it is a near certainty that a CRC will not match what has been previously read from the touchscreen monitor if a different monitor is substituted for the one from which the CRC was previously read. Thus, it is only necessary to determine if the CRC in the touchscreen data structure matches the value previously read to determine if the touchscreen monitor has been changed.

Beyond this, a CRC or other checksum 93 of the data stored in the touchscreen controller 40 makes it possible to determine if the touchscreen data 83 stored within the non-volatile memory device 54 has become corrupted.

It may be advantageous to store data within the non-volatile memory device 54 that is not directly related to touchscreen operation. The extended data structure 82 or 84 allows for this, however there are device-life limitations that must be considered. Specifically, non-volatile memory devices such as EEPROMs are limited in terms of the number of write cycles they can endure, with 1,000,000 cycles being a typical guaranteed minimum life expectancy. Various techniques can be used to maximize the life of a non-volatile memory device used in this way by minimizing the number of write cycles used for writing to the extended data area. A first technique utilize a page-write mode, if available, to maximize the amount of data being written to the non-volatile storage device with each write cycle. A second technique aligns the extended data structure with the page boundaries of the non-volatile memory device to minimize the number of pages that are written without crossing page boundaries. A third technique utilizes a CRC within the extended data structure itself 90 or 95, rather than relying on the CRC or checksum for the Touchscreen Data area 93, saving one write cycle that might otherwise be required if the extended data structure and touchscreen data area lie in different memory pages, as would typically be the case. A fourth technique is to utilize a larger memory device than might otherwise be needed if the larger device is able to write pages containing a larger number of bytes in single write cycle.

Exemplary logic for locating the touchscreen data structure within a non-volatile memory device 54 is shown in FIG. 14, which is typically executed when the operating system is started on the computer 12. The logic moves from a start block to block 400 where a string of length corresponding to the predefined signature is read from an address in the non-volatile memory device 54 that corresponds to the lowest address at which the top of the touchscreen data area 83 would be located (e.g., 8191). The string is then compared to the predefined unique signature string. If there is a match (yes at decision block 402), the logic moves to block 404 where a memory pointer for the top of the touchscreen data area is set to 8191 and the logic of FIG. 14 ends. If no signature match is found at 8191 (no at decision block 402), the same read-and-compare process is used to search for the signature at 16,383 (blocks 406-410), 32,767 (blocks 412-416) and 65,535 (blocks 418-422) until the signature is located. If the signature is located (yes in decision block 402, 408, 414 or 420), the pointer is set appropriately (block 404, 410, 416 or 422) and the logic of FIG. 14 ends. If the signature is not located at any of the addresses searched (no at decision block 420), the logic moves to block 424 where an error message is used to notify the user that a problem exists with the non-volatile memory 54 on the touchscreen controller 40 or with access to the touchscreen controller.

The diagram shown in FIG. 13 and the logic of FIG. 14 are directed to a typical application. It will be appreciated that other memory organizations can be used to the same effect.

FIG. 6 is a diagram illustrating an exemplary printed circuit board containing a complete touchscreen controller 40 designed to retrofit into an existing monitor. FIGS. 6A-6D are fractional detailed schematics of the circuit diagram shown in FIG. 6. The existing monitor shown can advantageously comprise a Sampo® PD-70FA16 LCD monitor manufactured by Sampoe Technologies, Incorporated of Norcross, Ga. Preferably, the printed circuit board fits within a Sampo® PD-70FA16 LCD monitor and replaces a small power distribution board. Power is routed through this new printed circuit board, eliminating the need for soldered wires to tap power from other sources.

For compatibility with a broad range of monitors, the new printed circuit board preferably, but optionally, includes a pin-header connector to allow the serial port and USB connector to be located at a distance from the touchscreen controller board.

The printed circuit board preferably includes a touch sensor interface. An exemplary touch sensor interface is a commercially available chipset from 3M® that can interface to a four-wire or eight-wire resistive touch sensor and communicate with a host processor using a serial protocol and standardized command set.

The printed circuit board also preferably includes a communications processor 52. Preferably, the communications processor 52 is a commercially available microprocessor. In the embodiment shown in FIG. 6, the microprocessor has two serial input/output ports and one USB input/output port. It will be appreciated that other configurations are possible, e.g., one serial input/output port and one USB input/output port, one serial input/output port and two USB input/output ports, etc. It will also be appreciated that in other embodiments, the input/output ports may include additional or different types of input/output ports, including currently existing types of input/output ports or future types of input/output ports. The communications processor 52 executes a program that is stored in a non-volatile memory device, e.g., EEPROM 54. The communications processor 52 an also read and write data to the EEPROM device 54.

When the communications processor 52 is initially started, it establishes a link with the touch sensor interface circuitry 50, and then it begins scanning the external serial 62 and USB input/output ports 64, looking for activity. Effectively, the first external input/output port on which activity is detected establishes the communication mode between the touchscreen controller 40 and the computer 12 to which it is attached, unless activity is first detected on the input/output port attached to the touch sensor interface circuitry 50, in which case the computer-communication mode is set to serial.

If activity is detected on the serial input/output port 62, all data from the touch sensor interface 50 is passed through the communications processor 52 and onto the computer 12 without alteration (in transparent mode). It would also be possible to provide an emulation mode in which the data would be translated to make the touchscreen monitor 30 appear to have come from a different manufacturer to broaden compatibility with software written specifically for other brands of touchscreen monitors. Commands from the computer 12 intended for the touch sensor interface 50 are also passed through the communications processor 52 without alteration (in transparent mode), however the data stream will be monitored for specific character sequences that access local control functions for the communications processor 52. These commands will most frequently be used to access the non-volatile memory device 54 for reading and writing calibration data serialization data, etc.

The touch sensor interface circuitry shown in FIG. 6 does not provide for external flow-control. Because the computer 12 may need to suspend the transmission of data from the touchscreen controller 40 to prevent overflow and data loss in serial mode, one function of the communications processor 52 is to provide a data buffering and flow control mechanism. Another function of the communications processor 52 is to monitor the RS-232 control lines that are used to implement the plug-and-play protocol, responding appropriately when the proper stimulus is received.

If activity is detected on the USB input/output port 64, the primary function of the communications processor 52 becomes encapsulation and de-encapsulation of the data coming from and going to the touch sensor interface circuitry 50. The non-volatile memory device 54 can also be accessed with specialized commands via the USB input/output port.

A unique identifier, such as a serial number, is stored in the non-volatile memory device 54 at the time of manufacture, and the device driver program that is running on the computer 12 can read this identifier. When multiple touchscreens 30 are attached to a single computer 12, as in FIGS. 7 and 8, the unique identifiers are used to identify which touch-input subsystem is paired with a particular display subsystem within the same physical enclosure.

Standardized factory calibration data is determined at the time of manufacture and written at that time to the non-volatile memory device 54. In this way valid calibration data stays with the monitor 30, even if it replaces another monitor or is moved to a different system.

The device driver software that is running on the computer 12 provides a second layer of data correction using locally derived calibration data. With this two-level data-correction process, a touchscreen 30 can be replaced without losing functionality and calibration, and it is easy to restore a system to factory calibration values if the user makes a mistake during the local user calibration process.

The non-volatile EEPROM device 54 is preferably partitioned into three to six regions: program memory from the bottom up, data from the top down, and an empty area between the top of the program code and the bottom of the data. Data is stored in a relatively small structure of fixed size and allocation. The fourth region, if it exists, lies in the area between the top of program code and the bottom of the data, and it is used for storing additional data. A fifth and sixth region can exist under certain circumstances.

Preferably, a unique four-byte data signature resides at the top of the data structure, making the structure easily identifiable. This feature allows the size of a non-volatile memory device to be changed, and the data structure to be moved as a result, while maintaining driver software compatibility. Other data signature sizes can be used and can be stored at other locations.

The non-volatile memory device can be made accessible for user applications that are unrelated to the touchscreen. Because non-volatile memory devices can have a very finite life, the otherwise empty space between the code and data is used for user applications with an independent structure that contains its own CRC for data-integrity validation. This structure is aligned to the memory-page boundaries of the non-volatile memory device, and a multi-byte write mode is used to further reduce the number of write cycles, and thus extend the life of the component.

Additional modifications and improvements of the present invention may also be apparent to those of ordinary skill in the art. Thus, the particular combination of parts described and illustrated herein is intended to represent only a certain embodiment of the present invention, and is not intended to serve as a limitation of alternative devices within the spirit and scope of the invention.

What is claimed is:

1. A method for selecting an active input/output port to be used for communicating between a computer input device and a computer, the method comprising:
(a) providing the computer input device having at least two input/output ports that are different types of input/output ports;
(b) monitoring each of the at least two input/output ports for an input signal until an input signal is received over one of the input/output ports; and
(c) selecting the input/output port that received the input signal as the active input/output port to be used for communication between the computer input device and the computer.

2. The method of claim 1, further comprising
before (b),
determining an expected protocol for each of the at least two input/output ports; and
after (b) but before (c),
verifying that the input signal received is the expected protocol for the input/output port that received the input signal.

3. The method of claim 1, wherein
(b) comprises monitoring each of the at least two input/output ports and a sensor interface port for an input signal until an input signal is received over one of the input/output ports or the sensor interface port; and
(c) comprises if the input signal was received over one of the input/output ports, selecting the input/output port that received the input signal as the active input/output port and if the signal was received over the sensor interface port, selecting a serial port as the active input/output port.

4. The method of claim 1, wherein the input device is a touchscreen monitor.

5. The method of claim 1, wherein the different types of input/output ports comprise a serial input/output port and a USB input/output port.

6. A system for selecting an active input/output port from a plurality of input/output ports of different types for communication between an input device and a computer, the system comprising:
(a) an input sensor for receiving an input signal; and
(b) an input device controller in communication with the input sensor and with the computer, the input device controller comprising:
i. an input interface configured to receive an input signal from the input sensor; and
ii. a communications processor configured to receive the input signal from the input/output ports, determine which of the input/output ports received the input signal, select the input/output port that received the input signal as the active input/output port and utilize the active input/output port for communication between the input device and the computer.

7. The system of claim 6, further comprising:
(c) a serial port; and
(d) a sensor interface port,
wherein the communications processor selects the serial port as the active input/output port if an input signal is received over the sensor interface port prior to a signal being received over one of the input/output ports.

8. The system of claim 6, further comprising non-volatile data storage that can be accessed by the communications processor, the non-volatile data storage used for storing the logic and data used by the communications processor.

9. The system of claim 6, wherein the communications processor is configured to validate that the input signal received from the input/output port is a valid input signal for the input/output port.

10. The system of claim 6, wherein the input device is a touchscreen monitor.

11. The system of claim 6, wherein the different types of input/output ports comprise a serial input/output port and a USB input/output port.

12. A method for a single computer to communicate with a plurality of input/output device pairs connected to the computer, each of the input/output device pairs comprising an input device, an output device and an input device controller, the output device being addressable by a specific computer display port which corresponds to a specific input device as components of a same input/output device pair, the method comprising:
(a) obtaining a unique identification code from the input device controller for each of the input/output device pairs connected to the computer;
(b) creating a table associating each unique identification code with the specific computer display port for the output device;
(c) obtaining input from the input device controller in a way that allows the unique identification code to be determined from input received from the input device controller;
(d) retrieving an identification of the specific computer display port for the output device from the table; and
(e) transmitting output to the output device via the specific computer display port based on the unique identification code.

13. The method of claim 12, wherein the input/output device pairs are touchscreen monitors.

14. The method of claim 12, wherein the computer communicates with the input/output device pairs using USB technology.

15. The method of claim 14, wherein the input/output device pairs communicate with the computer via a USB hub.

16. The method of claim 12, wherein the unique identification code is a serial number for the controller.

17. A method for uniquely associating calibration data for a particular touchscreen input subsystem including a touchscreen controller with a touchscreen monitor as a singular replaceable unit, the touchscreen monitor to be used with a computer, the method comprising:
(a) performing an initial factory calibration process to derive factory calibration data; and
(b) storing the factory calibration data in non-volatile memory in the touchscreen controller.

18. The method of claim 17, further comprising:
(c) performing a user calibration process to derive user calibration data; and
(d) storing the user calibration data in non-volatile memory in the touchscreen controller.

19. The method of claim 18, further comprising storing the user calibration data in non-volatile memory in the computer.

20. The method of claim 18, wherein the user calibration process is invoked by an end user.

21. The method of claim 18, further comprising:
(e) receiving raw touch-position data; and converting the raw touch-position data to calibrated touch-position data.

22. The method of claim 21, wherein converting the raw touch-position data to calibrated touch-position data comprises:
i. retrieving the factory calibration data;
ii. performing a first data-correction process using the factory calibration data to determine calibrated touch-position data;
iii. retrieving the user calibration data;
iv. if there is user calibration data, performing a second data-correction process using the user calibration data which modifies the calibrated touch-position data; and
v. storing the calibrated touch-position data.

23. The method of claim 17, wherein the initial factory calibration process is invoked by a manufacturer.

24. The method of claim 17, further comprising:
(c) receiving raw touch-position data; and
(d) converting the raw touch-position data to calibrated touch-position data.

25. The method of claim 25, wherein converting the raw touch-position data to calibrated touch-position data comprises:
i. retrieving the factory calibration data;
ii. performing a data-correction process using the factory calibration data to determine calibrated touch-position data; and storing the calibrated touch-position data.

26. A method for a computer to find specific data within variably-sized non-volatile memory device addressable by a controller, the method comprising:
(a) defining a limited number of predesignated locations in the non-volatile memory device for storage of the specific data;
(b) writing a unique predetermined bit pattern at one of the predesignated locations for the specific data, the unique predetermined bit pattern known to the computer; and
(c) writing the specific data in a predefined area adjacent to the predesignated location to which the unique predetermined bit pattern was written.

27. The method of claim 26, further comprising:
(d) searching for the unique predetermined bit pattern at the limited number of predesignated memory locations; and
(e) writing the specific data to the predefined area adjacent to the predesignated location to which the unique predetermined bit pattern was written.

28. The method of claim 27, further comprising reading the specific data from the predefined area adjacent to the predesignated location to which the unique predetermined bit pattern was written.

29. The method of claim 26, wherein the controller is a touchscreen controller.

30. The method of claim 29, wherein the data stored in the touchscreen controller is not directly related to the touchscreen operation.

31. The method of claim 26, further comprising writing a copy of the specific data in non-volatile memory of the computer in a way that survives power interruptions.

32. The method of claim 26, wherein the specific data includes cyclical redundancy check data.

33. The method of claim 26, wherein the specific data comprises calibration data.

34. The method of claim 26, wherein the specific data comprises data unique identification code.

35. The method of claim 34, wherein the unique identification code is a serial number.

36. The method of claim 26, wherein the specific data is aligned on a page boundary for the non-volatile memory device to minimize page writes thereby maximizing life of the non-volatile memory device.
